(19) United States
(12) Patent Application Publication
(10) Pub. No.: US 2025/0134143 A1
(43) Pub. Date: May 1, 2025

(54) MEAT QUALITY IMPROVER

(71) Applicant: NIPPN CORPORATION, Tokyo (JP)

(72) Inventor: Kasumi NAKAMURA, Atsugi-shi, Kanagawa (JP)

(73) Assignee: NIPPN CORPORATION, Tokyo (JP)

(21) Appl. No.: 18/687,596

(22) PCT Filed: Aug. 30, 2022
(86) PCT No.: PCT/JP2022/032560

§ 371 Date: Feb. 28, 2024

(30) Foreign Application Priority Data
Aug. 30, 2021 (JP) 2021-139834

(51) Int. Cl. A23L 13/72; A23L 7/10; A23L 13/77

(52) U.S. Cl. CPC A23L 13/72; A23L 7/198; A23L 13/77

(57) ABSTRACT

A meat quality improver is disclosed. The meat quality improver makes it possible to produce processed meat food products having a tender, juicy texture, and chewy fleshiness, even when meat such as farm-animal meat and fish meat is subjected to processing such as thermal cooking. The meat quality improver contains flour. A method for improving meat quality is disclosed, which includes a treatment of the meat with the meat quality improver containing flour when manufacturing the processed meat food products to obtain processed meat food products having a tender, juicy texture, and chewy fleshiness, even when meat such as farm-animal meat and fish meat is subjected to processing such as thermal cooking.

### TECHNICAL FIELD

The present invention relates to a meat quality improver.

### BACKGROUND ART

Meats, including farm-animal meats such as beef, pork, and chicken or other animal meats, and seafood meats such as fish and shellfish meats, are required to have tender and juicy textures that retain a meat juice and moisture and a chewy meat texture when cooked and eaten. However, when a meat is cooked by heating such as deep-frying, heating in an oven, heating in a frying pan, or heating in a microwave, the moisture and fat are lost due to scattering, leakage, or the like from the inside of the meat. For this reason, the heated meat tends to have tough, non-chewy, and dry textures. In addition, since the proteins that make up the meat denature, shrink, and coagulate due heating, the tough, non-chewy, and dry textures become more pronounced.

As general methods for improving the textures of a frying material in a fried meat food product, there are known and widely used a method for applying a proteolytic enzyme (Patent Literature 1) or a polymer phosphate (Patent Literature 2) to the meat. In the former method, the meat is softened by partial decomposition of meat proteins by the proteolytic enzyme. Meanwhile, in the latter method, the meat is softened by the calcium sequestration effect on meat proteins and the moisture-holding capacity is enhanced by increasing the pH. As a result, the meat used as a frying material has tender and juicy textures. Patent Literature 3 discloses a farm-animal meat quality improver containing a leavening agent, dietary fiber and/or gluconate, and states that the improver makes it possible to provide fried foods such as pork cutlet and chicken karaage having soft and juicy textures and improve the yield. Patent Literature 4 discloses a composition for fried food containing 0.5% by weight of phytosterol and states that the composition makes the juiciness of a frying material more favorable. All of the above means are effective for obtaining the juiciness of a frying material, but there is still a need for further improvement to meet a high market demand.

### CITATION LIST

### Patent Literatures

Patent Literature 1: Japanese Patent Application Publication No. H05-252911
Patent Literature 2: International Publication No. WO96/27300
Patent Literature 3: Japanese Patent Application Publication No. 2001-148
Patent Literature 4: Japanese Patent Application Publication No. 2003-235484

### SUMMARY OF INVENTION

### Problems to be Solved by the Invention

The present invention has an object to provide a meat quality improver that makes it possible to obtain a processed meat food product having tender and juicy textures and a chewy meat texture even if a meat such as a farm-animal meat or fish meat is processed by heat-cooking or the like.

### Means for Solution of the Problems

As a result of intensive studies to achieve the above-mentioned object, the present inventor found that, in production of a processed meat food product in which a meat such as a farm-animal meat or fish meat is treated with a meat quality improver containing wheat flour, it is possible to obtain the processed meat food product having tender and juicy textures and a chewy meat texture even if the meat is processed by heat cooking or the like.

In sum, the present invention includes the following aspects.
[1] A meat quality improver comprising wheat flour as an active ingredient.
[2] The meat quality improver according to [1], wherein the wheat flour contains or consists of wheat flour obtained by milling harvested wheat that does not lack GBSSI-A1 enzyme activity, lacks GBSSI-B1 and GBSSI-D1 enzyme activity, and lacks enzyme activity of any two of SSIIa-A1, SSIIa-B1, and SSIIa-D1 (GA-SX wheat flour).
[3] The meat quality improver according to [2], wherein the GA-SX wheat flour is wheat flour obtained by milling harvested wheat that does not lack GBSSI-A1 enzyme activity, lacks GBSSI-B1 and GBSSI-D1 enzyme activity, does not lack SSIIa-A1 enzyme activity, and lack SSIIa-B1 and SSIIa-D1 enzyme activity (GA-SA wheat flour).
[4] Use of the meat quality improver according to any one of [1] to [3] for improving meat quality of a meat, wherein the wheat flour is used in an amount of 0.01 parts by mass per 100 parts by mass of the meat.
[5] A meat quality improvement method comprising the step of treating a meat with the meat quality improver according to any one of [1] to [3].
[6] The meat quality improvement method according to [5], wherein the treating the meat with the meat quality improver includes adding the meat quality improver to the meat by a tumbling treatment and/or an injection treatment.
[7] The meat quality improvement method according to [5] or [6], wherein the meat quality improver is used in such an amount that an amount of the wheat flour contained in the meat quality improver is 0.01 parts by mass or more per 100 parts by mass of the meat.
[8] A method for producing a processed meat food product comprising the steps of:
   treating a meat with the meat quality improver according to any one of [1] to [3]; and
   heating the treated meat.
[9] The method for producing a processed meat food product according to [8], wherein the treating the meat with the meat quality improver includes adding the meat quality improver to the meat by a tumbling treatment and/or an injection treatment.
[10] The method for producing a processed meat food product according to [8] or [9], wherein the meat quality improver is used in such an amount that an amount of the wheat flour contained in the meat quality improver is 0.01 parts by mass or more per 100 parts by mass of the meat.

### Advantageous Effects of Invention

Even when a meat such as a farm-animal meat, other animal meat, or a seafood meat is processed by heat cooking or the like, it is possible to obtain a processed meat food product not having dry and tough meat quality but having tender and juicy textures and a chewy meat texture by treating the meat with a meat quality improver of the present invention even without using a special raw material such as a proteolytic enzyme or a polymer phosphate.

### DESCRIPTION OF EMBODIMENTS

### <Meat Quality Improver>

A meat quality improver of the present invention contains wheat flour as an active ingredient. The wheat flour contained in the meat quality improver of the present invention is not particularly limited and may be wheat flour obtained by milling commonly available wheat or may be commercially available wheat flour. However, among all, the meat quality improver preferably contains wheat flour obtained by milling harvested wheat that does not lack GBSSI-A1 enzyme activity, lacks GBSSI-B1 and GBSSI-D1 enzyme activity, and lacks enzyme activity of any two of SSIIa-A1, SSIIa-B1, and SSIIa-D1 (GA-SX wheat flour).

Common wheat is an allohexaploid and its chromosomes are three homoeologous chromosomes A, B, and D, numbered 1 to 7 (1A to 7A, 1B to 7B, and ID to 7D).

“GBSSI” is a granule-bound starch synthase involved in the synthesis of amylose, and GBSSI-A1, GBSSI-B1, and GBSSI-D1 are encoded by genes located on chromosomes 7A, 4A, and 7D, respectively.

“SSIIa” is a starch synthase involved in the branched chain synthesis of amylopectin, and SSIIa-A1, SSIIa-B1, and SSIIa-D1 are encoded by genes located on chromosomes 7A, 7B, and 7D, respectively.

The phrase “lacks enzyme activity” means a condition where a protein with normal enzyme activity is not functioning in a wheat plant, or preferably the protein with normal enzyme activity is not expressed therein. Specifically, examples of such a condition include mutations in a gene sequence (referring to mutations such as a substitution, a deletion, an insertion, an inversion, and a translocation of one or more bases, including deletion of the entire gene region), a defect in mRNA transcription, a defect in protein translation, an inhibition of enzyme activity within a wheat plant, and so on. Any of the conditions may be taken as long as the enzyme activity is reduced or deleted to less than 10%, preferably less than 5%, and more preferably less than 1% of the wild-type enzyme activity.

As the GA-SX wheat flour, there are the following types of wheat flour depending on a combination of two types of SSIIa lacking enzyme activity:
GA-SA wheat flour: wheat flour obtained by milling harvested wheat that does not lack GBSSI-A1 enzyme activity, lacks GBSSI-B1 and GBSSI-D1 enzyme activity, does not lack SSIIa-A1 enzyme activity, and lacks SSIIa-B1 and SSIIa-D1 enzyme activity;
GA-SB wheat flour: wheat flour obtained by milling harvested wheat that does not lack GBSSI-A1 enzyme activity, lacks GBSSI-B1 and GBSSI-D1 enzyme activity, does not lack SSIIa-B1 enzyme activity, and lacks SSIIa-A1 and SSIIa-D1 enzyme activity; and
GA-SD wheat flour: wheat flour obtained by milling harvested wheat that does not lack GBSSI-A1 enzyme activity, lacks GBSSI-B1 and GBSSI-D1 enzyme activity, does not lack SSIIa-D1 enzyme activity, and lacks SSIIa-A1 and SSIIa-B1 enzyme activity.

Among these, the GA-SA wheat flour is preferable.

The GA-SX wheat flour can be produced according to a known method, for example, the method described in Japanese Patent Application Publication No. 2013-188206.

The meat quality improver of the present invention may consist of wheat flour or may contain any commonly-used ingredient such as an excipient as needed. The agent form of the meat quality improver may be any easy-to-handle form, and a desired form may be selected from, for example, powder, fine granule, granule, tablet, liquid, and so on. The meat quality improver of the present invention may be used as it is. Instead, depending on a use purpose or use method, the meat quality improver may be mixed with another ingredient and used as a meat quality improver in a powder form, a liquid form, or the like.

In the case of use in a powder form of the composition for meat quality improvement, other ingredients may include grain flours other than wheat flour such as durum wheat flour, barley flour, rye flour, rice flour, buckwheat flour, corn flour, soybean flour, and the like, and their waxy or high amylose flours; starches (for example, wheat starch, corn starch, tapioca starch, potato starch, mung bean starch, sago starch, and the like, and their waxy starches or high amylose starches) and processed starches thereof obtained by gelatinization, etherification, esterification, acetylation, crosslinking treatment, and so on; inorganic salts such as common salt; sugars such as sucrose, maltose, sorbitol, trehalose, stevia, soft brown sugar (san-ontou), brown sugar (koku-to), and glucose; spices such as white pepper, black pepper, garlic, nutmeg, rosemary, sage, oregano, allspice, and their powders; seeds such as flaxseed, peanut, almond, ginkgo nut, wolfberry, sesame, and walnut, and their powders; tuberous roots such as potato, sweet potato, taro, yam, and carrot, and their powders; dry powders of vegetables such as kale, spinach, cabbage, and Chinese cabbage; umami seasonings such as monosodium glutamate and sodium inosinate; powdered egg ingredients which are powdered egg yolk, egg white, and whole egg, and other egg-derived ingredients; powdered milk ingredients such as milk powder, skim milk powder, and soybean milk powder; proteins such as soybean protein, wheat protein, and pea protein; vitamins such as ascorbic acid, thiamine, pantothenic acid, niacin, and folic acid; organic acids such as acetic acid, lactic acid, and citric acid; water-insoluble dietary fibers such as indigestible starch; water-soluble dietary fibers such as polydextrose, barley β-glucan, and indigestible dextrin; antioxidants such as tocopherol, propyl gallate, chlorogenic acid, sodium sulfite, butylhydroxyanisole, and catechin; coloring agents such as β-carotene, caramel, and red yeast rice pigment; extracts such as consommé, bouillon, bonito stock, and yeast extract; fermented seasonings such as yogurt, cheese, and soy sauce, and their dry powders; enzymes such as amylase, protease, cellulase, lipase, and transglutaminase; polysaccharide thickeners such as agar, gelatin, inulin, carrageenan, gellan gum, xanthan gum, locust bean gum, tamarind seed gum, sodium alginate, pectin, curdlan, and cellulose derivatives; excipients such as lactose and mannitol; anti-caking agents such as ferrous ammonium citrate, anhydrous sodium phosphate, calcium phosphate, anhydrous magnesium sulfate, magnesium chloride, calcium chloride, magnesium carbonate, calcium carbonate, fine silicon dioxide, and magnesium oxide; starch decomposition products such as dextrin, cyclodextrin, and highly branched cyclic dextrin; fragrances; alcoholic beverages; oligosaccharides; stabilizers; preservatives; and so on. One, two, or more of them may be selected and used as needed. Note that the other ingredients such as grain flours, starches, and seeds may be optionally subjected to any of treatments such as a dry heating treatment, a moist heating treatment, and an enzyme treatment.

In the case of use in a liquid form of the composition for meat quality improvement, other ingredients may include drinking water such as mineral water and soft drinks; milks such as cow's milk, goat's milk, and horse's milk, and fermented milk drinks made by fermenting them; egg liquids such as whole egg liquid, egg yolk liquid, and egg white liquid derived from poultry such as chicken, quail, and ostrich; fruit juices such as orange juice, grapefruit juice, pineapple juice, and their concentrated reduced fruit juices thereof; and so on. In the case of use in the liquid form, the meat quality improver may contain any of the other ingredients usable in the case of use in the powder form.

The meat quality improver of the present invention preferably contains 80% by mass or more of the wheat flour, more preferably contains 90% by mass or more of the wheat flour, or further preferably consists of the wheat flour.

The content of the meat quality improver in the composition for meat quality improvement in the present invention is not particularly limited. From the viewpoint that the effects of the present invention in production of processed meat food products can be more exerted, the lower limit of the amount of the wheat flour contained in the meat quality improver relative to the total amount of the composition for meat quality improvement is preferably 0.1% by mass or more, more preferably 1.01% by mass or more, and further preferably 20.0% by mass or more.

In the case of the powder composition for meat quality improvement, the higher the content of the meat quality improver contained in the composition for meat quality improvement, the better from the viewpoint of efficiency. Therefore, the upper limit of the content is preferably 80% by mass or less, more preferably 90% by mass or less, and further preferably 100% by mass.

In the case of the liquid composition for meat quality improvement, the upper limit of the content of the meat quality improver contained in the composition for meat quality improvement is preferably 60% or less, more preferably 40% or less 40% or less, and further preferably 30% or less from the viewpoint of ease of handling.

A long as the meat quality improver of the present invention contains the wheat flour, processed meat food products having tender and juicy textures and a chewy meat texture can be obtained. In addition, in the case where the GA-SX wheat flour is used as the wheat flour, the improvement effects are more prominent. In this case, the wheat flour contained in the meat quality improver of the present invention may consist of the GA-SX wheat flour or may be a mixture of the GA-SX wheat flour and wheat flour other than the GA-SX wheat flour.

In the case where the wheat flour contained in the meat quality improver of the present invention is a mixture of the GA-SX wheat flour and wheat flour other than the GA-SX wheat flour, the meat quality improvement effects tend to be higher as the content of the GA-SX wheat flour increases.

Meats to which the meat quality improver of the present invention is to be applied are not particularly limited, and the meat quality improver can be suitably applied to any commonly eaten meat.

Such meats includes meats of: mammals such as cow, pig, horse, sheep, goat, rabbit, boar, and deer; poultry such as chicken, quail, duck, goose, duck, turkey, and ostrich; fishes such as tuna, salmon, cod, sea bream, marlin, sardine, mackerel, horse mackerel, saury, eel, carp, and crucian carp; marine mammals such as whale, dolphin, seal, and walrus; reptiles such as crocodile, turtle, and snake; amphibians such as frog and salamander; molluscs such as octopus and squid; shellfishes such as scallop, asari clam, and clam; crustaceans such as spiny lobster and prawn; and so on. One of these meats may be used alone or a mixture of two or more of them may be used.

Parts of a meat are not particularly limited, and may be: sirloin, fillet, loin, rib roast, rump, and so on in the case of beef; loin, fillet, belly, thigh, and so on in the case of pork; and breast, thigh, chicken wing, fillet, and so on in the case of chicken. The form of a meat is not particularly limited and may be a meat in a form such as a block form, a cut form, a dice form, a stick form, a slice form, a minced form, and a paste form.

### <Meat Quality Improvement Method>

The meat quality improvement method of the present invention includes a step of treating a meat with the meat quality improver containing the wheat flour in the present invention. Here, a method for “treating a meat with the meat quality improver” is not particularly limited as long as the method allows the meat to come into contact with the wheat flour contained in the meat quality improver. Examples thereof include injection (a treatment of mechanically injecting the meat quality improver or a composition for meat quality improvement such as a seasoning liquid containing the same into the meat), tumbling (a treatment of mechanically infiltrating the meat with the meat quality improver or a composition for meat quality improvement such as a seasoning liquid containing the same), pickling (a treatment of adding the meat quality improver or a composition for meat quality improvement such as a seasoning liquid containing the same to the meat and leaving it to stand for pickling), spraying (a treatment of mechanically spraying the meat quality improver or a composition for meat quality improvement such as a seasoning liquid containing the same onto the meat), application (a treatment of applying the meat quality improver or a composition for meat quality improvement such as a seasoning liquid containing the same onto the meat using a brush or the like), sprinkling (a treatment of sprinkling a powder meat quality improver or composition for meat quality improvement such as a powdered seasoning containing the same over the meat), stewing (a treatment of stewing the meat together with a composition for meat quality improvement such as a stock containing the meat quality improver), and so on. One, two, or more of these methods can be employed. From the viewpoint that the meat quality improver of the present invention can be taken into a meat and improve the meat quality effectively, the injection and/or tumbling are preferable. In the meat quality improvement method of the present invention, the treating a meat with the meat quality improver preferably includes adding the meat quality improver to the meat by the injection treatment and/or the tumbling treatment.

The tumbling treatment can be carried out by using, for example, a device called a tumbler, which includes at least a drum with optional partition plates (wings) inside and a rotation mechanism for rotating the drum. Specifically, a meat is put into the drum of the tumbler together with the meat quality improver, and the drum is rotated to continuously apply physical impact to the meat in the presence of the meat quality improver, thereby promoting penetration of the meat quality improver into the meat.

The injection treatment can be carried out by using a syringe or injector.

The amount of the meat quality improver used may be set as appropriate in consideration of the type, meat quality, size, and shape of a meat for use, the meat quality improvement method employed, and so on. From the viewpoint that the meat quality can be effectively improved, the amount of the meat quality improver used is such that the amount of the wheat flour contained in the meat quality improver per 100 parts by mass of a meat is 0.01 parts by mass or more, preferably 0.05 parts by mass or more, more preferably 0.5 parts by mass or more, and further preferably 1.0 parts by mass or more. The upper limit of the amount of the wheat flour used is not particularly limited. However, from the viewpoint of production efficiency, the upper limit per 100 parts by mass of a meat is 15 parts by mass or less, preferably 12 parts by mass or less, and more preferably 8.0 parts by mass or less. Use of the wheat flour in the above range makes it possible to suitably improve the meat quality of a meat. In addition, in the case where the GA-SX wheat flour is used as the wheat flour, the improvement effects are more prominent. In this case, the wheat flour contained in the meat quality improver of the present invention may consist of the GA-SX wheat flour or may be a mixture of the GA-SX wheat flour and wheat flour other than the GA-SX wheat flour. In the case where the wheat flour contained in the meat quality improver of the present invention is a mixture of the GA-SX wheat flour and wheat flour other than the GA-SX wheat flour, the meat quality improvement effects tend to be higher as the content of the GA-SX wheat flour increases.

In the case where the meat quality improver is used in a form of a composition for meat quality improvement, the content of the meat quality improver in the composition for meat quality improvement is not particularly limited. From the viewpoint that the effects of the present invention in production of processed meat food products can be more exerted, the lower limit of the amount of the wheat flour contained in the meat quality improver relative to the total amount of the composition for meat quality improvement is preferably 0.1% by mass or more, more preferably 10.0% by mass or more, and further preferably 20.0% by mass or more.

In the case of the powder composition for meat quality improvement, the higher the content of the meat quality improver contained in the composition for meat quality improvement, the better from the viewpoint of efficiency. Therefore, the upper limit of the content is preferably 80% by mass or less, more preferably 90% by mass or less, and further preferably 100% by mass.

In the case of the liquid composition for meat quality improvement, the upper limit of the content of the meat quality improver contained in the composition for meat quality improvement is preferably 60% or less, more preferably 40% or less, and further preferably 30% or less from the viewpoint of ease of handling.

In the case where the meat quality improver is used in a powder form of a composition for meat quality improvement, the amount of the composition for meat quality improvement used per 100 parts by mass of a meat is in a range of preferably 1 to 30 parts by mass, more preferably 5 to 25 parts by mass, and further preferably 15 to 20 parts by mass. In the case where the meat quality improver is used in a liquid form of a composition for meat quality improvement, the amount of the composition for meat quality improvement used per 100 parts by mass of a meat is in a range of preferably 5 to 50 parts by mass, more preferably 10 to 40 parts by mass, and further preferably 15 to 30 parts by mass.

A treatment time for treating a meat with the meat quality improver is not particularly limited and may be preferably 10 seconds to 24 hours, more preferably 1 minute to 2 hours, and further preferably 2 minutes to 1 hour. Although the longer treatment time may achieve a higher meat quality improvement effect, the treatment time is desired to be within 1 hour from the viewpoint of production efficiency.

### <Method for Producing Processed Meat Food Product>

In the present invention, a processed meat food product means a food obtained by processing a meat by heating.

The method for producing a processed meat food product in the present invention includes a step of treating a meat with the above-mentioned meat quality improver and a step of heating the meat modified with the meat quality improver.

The processed meat food products obtained in the method for producing a processed meat food product in the present invention are not particularly limited, and may be: deep-fried meats such as chicken karaage, tatsuta-age, fried chicken, pork cutlet, beef cutlet, fried tuna, fried salmon, fried shrimp, fried scallop, and fritter, and non-fried deep-fry-like meats; grilled meats such as steak, roast beef, roast pork, grilled chicken, and grilled fish; stewed meats such as curry, stew, and pot-au-feu; salted and/or smoked meats such as boneless ham, bacon, sausage, and smoked salmon; minced or pasted meat products such as Hamburg stake, meatball, tsukune, tsumire, kamaboko, and chikuwa; dried meats such as beef jerky and dried horse mackerell; and so on.

Among these, fried meats, grilled meats, and stewed meats are preferable and fried meats and grilled meats are more preferable from the viewpoint that the effects of the present invention can be obtained favorably.

In the method for producing a processed meat food product in the present invention, the treatment method in the step of treating a meat with the meat quality improver is as described in the “meat quality improvement method”.

The method for producing a processed meat food product in the present invention further includes a step of heating the meat treated with the meat quality improver. The heating method is not particularly limited, and may be deep-fry heating (in oil), heating in a frying pan, heating in an oven, direct flame heating, smoke heating, steam heating, steam convection heating, superheated steam heating, stewing heating, microwave heating, or the like. The heating temperature is not particularly limited, and can be adjusted as appropriate depending on a processed meat food product to be produced. For example, the heating temperature is 160 to 220° C. for deep-fry heating, 170 to 240° C. for heating in a frying pan, 70 to 300° C. for heating in an oven, 30 to 100° C. for smoke heating, 50 to 100° C. for steam heating, 100 to 350° C. for superheated steam heating, 50 to 100° C. for stewing heating.

The obtained processed meat food product may be frozen rapidly to be stored frozen, and then reheated after or without thawing. For example, in the case of chicken karaage, a batter is attached to chicken thigh treated with the meat quality improver, the chicken thigh is fried in a hot oil bath, cooled down slightly, and then rapidly frozen at −40° C., thereby producing the frozen chicken karaage. Then, the frozen chicken karaage is stored in the freezer of a household refrigerator for 10 days, and then is re-fried in a hot oil bath or heated in a microwave oven to obtain the chicken karaage.

In addition, in the present invention, a meat treated with the meat quality improver can be frozen or refrigerated without heating to produce the frozen or refrigerated processed meat. For example, in the case of chicken karaage, a batter is attached to chicken thigh treated with the meat quality improver, the chicken thigh is stored in a container and then rapidly frozen at −40° C., thereby producing the frozen chicken karaage before deep frying. Then, the frozen chicken karaage before deep frying is stored in the freezer of a household refrigerator, and then is heated by deep-frying in a thawed or unthawed state in a hot oil bath to obtain the chicken karaage.

### EXAMPLES

Hereinafter, the present invention will be described in further details based on Examples, but the present invention should not be limited to these Examples.

### Production Example 1: Production of Marinade Liquid

Here, 17.8 parts by mass of a marinade liquid was produced by putting 1.2 parts by mass of common salt, 1.0 parts by mass of grated ginger, 0.5 parts by mass of sugar, 0.3 parts by mass of monosodium glutamate, 0.3 parts by mass of black pepper powder, and 14.5 parts by mass of drinking water into a mixer and mixing them until homogeneous.

### Production Example 2: Production of Chicken Karaage (Fried Meat) Using Marinade Liquid

(1) 300 g of a chicken thigh block was cut into 10 chicken thigh pieces of approximately 30 g.
(2) The total amount of the marinade liquid obtained according to Production Example 1 (17.8 parts by mass) and 100 parts by mass of the chicken thigh pieces were put together and subjected to the tumbling treatment for 30 minutes. After the tumbling, there was almost no marinade liquid remaining in the tumbler.
(3) The pre-seasoned chicken thigh pieces were put into a batter liquid (under the trade name “Pari-Kara Shoyu” manufactured by NIPPN CORPORATION), and thereby the batter liquid was attached to the chicken thigh pieces to obtain chicken karaage before deep frying.
(4) The obtained chicken karaage before deep frying was put into an oil bath preheated to 175° C. and then fried for 4 minutes. The fried chicken karaage pieces were placed without overlapping on a metal tray for oil drainage, and the oil was drained to obtain the chicken karaage.

### Evaluation Example 1: Sensory Evaluation of Meat Quality of Chicken Karaage (Fried Meat)

The obtained chicken karaage was tested by 10 experienced panelists in a sensory evaluation of the meat quality of the frying material, that is, the chicken meat according to the following criteria, and the mean score was taken as the evaluation score. SD is an abbreviation of standard deviation. Note that the evaluation score for the chicken meat as the frying material in the chicken karaage produced by using the marinade liquid obtained in Production Example 1 (Control Example 1) was set to 3 points.

### [Sensory Evaluation Tables]

Tenderness

| | |
|---|---|
| 5 points | Tender and very good |
| 4 points | Fairly tender and good |
| 3 points | Normal |
| 2 points | Slightly tough and bad. |
| 1 point | Tough and very bad |

Juiciness

| | |
|---|---|
| 5 points | Juicy and very good |
| 4 points | Fairly juicy and good |
| 3 points | Normal |
| 2 points | Slightly dry and bad |
| 1 point | Dry and very bad |

Chewiness

| | |
|---|---|
| 5 points | Chewy and very good |
| 4 points | Fairly chewy and good |
| 3 points | Normal |
| 2 points | Slightly non-chewy and bad |
| 1 point | Non-chewy and very bad |

### Test Example 1: Wheat Flour's Influence on Meat Quality of Chicken Karaage (Fried Meat)

A marinade liquid was prepared according to Production Example 1 except that the wheat flour was further added in an amount specified with parts by mass in Table 1, chicken karaage was produced according to Production Example 2, and the meat quality of the chicken meat as the frying material was evaluated according to Evaluation Example 1. In the preparation of the marinade liquid, the wheat flour was additionally blended to the total amount of the ingredients other than the wheat flour (when 1.0 parts by mass of the wheat flour was used, the total amount of the marinade liquid was 18.8 parts by mass).

As a result, in Examples 1 to 5 in which the GA-SA wheat flour was used as the wheat flour, the tenderness and juiciness of the chicken meat as the frying material became more favorable as the ratio of the GA-SA wheat flour blended increased. This is presumably because the frying material retained the meat juice, moisture, fat, and the like as a result of suppressing the scattering and leakage of the meat juice, moisture, fat, and the like from the frying material due to deep frying in oil. In addition, the chewiness of the meat became also more favorable as the amount of the GA-SA wheat flour used increased. The reason for the improved chewiness is unclear, but it is thought that the wheat flour may have had some effects on the shrinkage and coagulation of the meat caused by the denaturation of meat proteins due to heating.

Even in Examples 6 to 10, which used only standard wheat flour, the tenderness, juiciness, and chewiness of the meat quality of the frying material improved depending on the amount of the wheat flour used, but the effects of them were lower than in the case with the GA-SA wheat flour.

In Examples 11 and 12 which each used a mixture of the GA-SA wheat flour and the standard wheat flour, because the GA-SA wheat flour was contained, the tenderness, juiciness, and chewiness of the chicken meat as the frying material more prominently improved than in Example 9 which used the same amount of the wheat flour in total.

TABLE 1

| | | | | | | | Control |
|---|---|---|---|---|---|---|---|
| | | Example | | | | | Example |
| | | 1 | 2 | 3 | 4 | 5 | 1 |
| GA-SA Wheat Flour | | 0.1 | 0.2 | 2.0 | 5.0 | 10.0 | 0 |
| Standard Wheat Flour | | 0 | 0 | 0 | 0 | 0 | 0 |
| Tenderness | Mean | 3.3 | 3.7 | 4.5 | 4.7 | 4.8 | 3.0 |
| | SD | 0.48 | 0.48 | 0.53 | 0.48 | 0.42 | — |
| Juiciness | Mean | 3.4 | 3.7 | 4.4 | 4.7 | 4.7 | 3.0 |
| | SD | 0.52 | 0.48 | 0.52 | 0.48 | 0.48 | — |
| Chewiness | Mean | 3.4 | 3.8 | 4.6 | 4.8 | 4.5 | 3.0 |
| | SD | 0.52 | 0.42 | 0.52 | 0.42 | 0.53 | — |

| | | Example | | | | | | |
|---|---|---|---|---|---|---|---|---|
| | | 6 | 7 | 8 | 9 | 10 | 11 | 12 |
| GA-SA Wheat Flour | | 0 | 0 | 0 | 0 | 0 | 0.2 | 2.0 |
| Standard Wheat Flour | | 0.1 | 0.2 | 2.0 | 5.0 | 10.0 | 4.8 | 3.0 |
| Tenderness | Mean | 3.1 | 3.1 | 3.3 | 3.7 | 3.8 | 4.2 | 4.6 |
| | SD | 0.32 | 0.32 | 0.48 | 0.48 | 0.42 | 0.42 | 0.52 |
| Juiciness | Mean | 3.1 | 3.2 | 3.3 | 3.8 | 3.8 | 4.3 | 4.6 |
| | SD | 0.32 | 0.42 | 0.48 | 0.42 | 0.42 | 0.48 | 0.52 |
| Chewiness | Mean | 3.2 | 3.2 | 3.4 | 3.8 | 3.5 | 4.3 | 4.7 |
| | SD | 0.42 | 0.42 | 0.52 | 0.42 | 0.53 | 0.48 | 0.48 |

The standard wheat flour was a product under the trade name DIA manufactured by NIPPN CORPORATION.

### Production Example 3: Production of Chicken Steak (Grilled Meat) Using Marinade Liquid

(1) A chicken breast was trimmed into a substantially rectangular parallelepiped with a length of 10 cm, a width of 5 cm, and a thickness of 2 cm.
(2) 100 parts by mass of the chicken breast and the total amount (17.8 parts by mass) of the marinade liquid produced according to Production Example 1 were put into a tumbler and subjected to the tumbling treatment for 30 minutes.
(3) The tumbled chicken breast was placed on an iron plate preheated to 220° C. and grilled until the inside of the chicken breast was cooked to obtain a chicken steak.

### Test Example 2: Wheat Flour's Influence on Meat Quality of Chicken Steak (Grilled Meat)

A chicken steak was produced according to Production Example 3 except that the wheat flour was further used in an amount specified with parts by mass in Table 2, and was evaluated according to Evaluation Example 1. In the preparation of the marinade liquid, the wheat flour was additionally blended to the total amount of the ingredients other than the wheat flour. The evaluation scores for the meat tenderness, juiciness, and chewiness of the chicken steak obtained according to Production Example 3 (Control Example 2) were set to 3 points.

As a result, the use of the marinade liquid containing the GA-SA wheat flour improved the tenderness, juiciness, and chewiness of the chicken breast as the raw material as the ratio of the GA-SA wheat flour blended increased. Also in the case of using the standard wheat flour, the tenderness, juiciness, and chewiness were improved, but the improvements were inferior to those in the case with the GA-SA wheat flour.

TABLE 2

| | | | | | | Control |
|---|---|---|---|---|---|---|
| | | Example | | | | Example |
| | | 13 | 14 | 15 | 16 | 2 |
| GA-SA Wheat Flour | | 0.2 | 2.0 | 0 | 0 | 0 |
| Standard Wheat Flour | | 0 | 0 | 0.2 | 2.0 | 0 |
| Tenderness | Mean | 3.6 | 4.3 | 3.1 | 3.3 | 3.0 |
| | SD | 0.52 | 0.48 | 0.32 | 0.48 | — |
| Juiciness | Mean | 3.6 | 4.4 | 3.1 | 3.4 | 3.0 |
| | SD | 0.52 | 0.52 | 0.32 | 0.52 | — |
| Chewiness | Mean | 3.7 | 4.7 | 3.2 | 3.3 | 3.0 |
| | SD | 0.48 | 0.48 | 0.42 | 0.48 | — |

### Production Example 4: Production of Beef Steak (Grilled Meat) Using Marinade Liquid

(1) A pickle liquid was prepared by adding water to the marinade liquid of Production Example 1 such that the total amount became 20 parts by mass.
(2) An Australian beef lean meat was trimmed into a substantially rectangular parallelepiped with a thickness of 2 cm, a length of 10 cm, and a width of 20 cm.
(3) The trimmed lean beef meat pieces were placed on a tray with no gap in between, and the pickle liquid was injected in an amount of 20 parts by mass per 100 parts by mass of the lean beef meat pieces.
(4) The lean beef meat piece injected with the pickle liquid was placed on an iron plate preheated to 220° C. and grilled to a medium-rate state to obtain a beef steak.

### Test Example 2: Wheat Flour's Influence on Textures of Beef Steak (Grilled Meat)

A beef steak was produced according to Production Example 4 except that the wheat flour was further used in an amount specified with parts by mass in Table 3, and was evaluated according to Evaluation Example 1. In the preparation of the pickle liquid, the amount of the wheat flour was included and the total of the marinade liquid (total amount), the wheat flour, and the water was 20 parts by mass. In the evaluation, the evaluation scores for the meat tenderness, juiciness, and chewiness of the beef steak obtained according to Production Example 4 (Control Example 3) were set to 3 points.

As a result, in all the beef steaks in the case where the wheat flour was used in the pickle liquid, the tenderness, juiciness, and chewiness improved and the effects were the most prominent in Example 17 using the GA-SA wheat flour.

TABLE 3

| | |
|---|---|
| | Control |
| Example | Example |

| | | 17 | 18 | 3 |
|---|---|---|---|---|
| GA-SA Wheat Flour | | 1.0 | 0 | 0 |
| Standard Wheat Flour | | 0 | 1.0 | 0 |
| Tenderness | Mean | 4.0 | 3.3 | 3.0 |
| | SD | 0.00 | 0.48 | — |
| Juiciness | Mean | 4.1 | 3.4 | 3.0 |
| | SD | 0.32 | 0.52 | — |
| Chewiness | Mean | 4.3 | 3.4 | 3.0 |
| | SD | 0.48 | 0.52 | — |

1. (canceled)

2. A meat quality improver comprising wheat flour as an active ingredient, wherein the wheat flour contains or consists of wheat flour obtained by milling harvested wheat that does not lack GBSSI-A1 enzyme activity, lacks GBSSI-B1 and GBSSI-D1 enzyme activity, and lacks enzyme activity of any two of SSIIa-A1, SSIIa-B1, and SSIIa-D1 (GA-SX wheat flour).

3. The meat quality improver according to claim 2, wherein the GA-SX wheat flour is wheat flour obtained by milling harvested wheat that does not lack GBSSI-A1 enzyme activity, lacks GBSSI-B1 and GBSSI-D1 enzyme activity, does not lack SSIIa-A1 enzyme activity, and lacks SSIIa-B1 and SSIIa-D1 enzyme activity (GA-SA wheat flour).

4. (canceled)

5. A meat quality improvement method comprising the step of treating a meat with the meat quality improver according to claim 2.

6. The meat quality improvement method according to claim 5, wherein the treating the meat with the meat quality improver includes adding the meat quality improver to the meat by a tumbling treatment and/or an injection treatment.

7. The meat quality improvement method according to claim 5, wherein the meat quality improver is used in such an amount that an amount of the wheat flour contained in the meat quality improver is 0.01 parts by mass or more per 100 parts by mass of the meat.

8. A method for producing a processed meat food product comprising the steps of:
treating a meat with the meat quality improver according to claim 2; and
heating the treated meat.

9. The method for producing a processed meat food product according to claim 8, wherein the treating the meat with the meat quality improver includes adding the meat quality improver to the meat by a tumbling treatment and/or an injection treatment.

10. The method for producing a processed meat food product according to claim 8, wherein the meat quality improver is used in such an amount that an amount of the wheat flour contained in the meat quality improver is 0.01 parts by mass or more per 100 parts by mass of the meat.
